(19) United States
(12) Patent Application Publication
(10) Pub. No.: US 2009/0116750 A1
(43) Pub. Date: May 7, 2009

(54) COLOR INTERPOLATION METHOD AND DEVICE

(76) Inventors: Ho-Young Lee, Seoul (KR); Hwang-Young So, Gyeonggi-do (KR)

Correspondence Address: BIRCH STEWART KOLASCH & BIRCH, PO BOX 747, FALLS CHURCH, VA, 22040-0747, US

(21) Appl. No.: 12/300,063

(22) PCT Filed: May 30, 2007
(86) PCT No.: PCT/KR07/02611

§ 371 Date: Nov. 7, 2008

(30) Foreign Application Priority Data
May 30, 2006 (KR) 10 2006 0048982

(51) Int. Cl. G06K 9/48; H04N 9/04

(52) U.S. Cl. 382/199; 348/273; 348/E09.01

(57) ABSTRACT

A color interpolation method and device are disclosed. The color interpolation method includes (a) extracting a pixel value only from a Bayer pattern image regardless of R, G and B values and computing edge directional information; (b) determining a condition of the edge directional information, computed in the step of (a), among a plurality of predetermined conditions, each of the plurality of predetermined conditions corresponding to a color interpolation parameter computing algorithm; and (c) computing a color interpolation parameter based on the color interpolation parameter computing algorithm corresponding to the condition of the edge directional information, determined in the step of (b). With the present invention, wrong color can be prevented from being generated in the vicinity of minute edge having 700 or more, and zipper-shaped artifact can be prevented from being generated in the vicinity of edge.

### CROSS-REFERENCE TO RELATED APPLICATIONS

This application claims foreign priority benefits under 35 U.S.C. .sctn. 119(a)-(d) to PCT/KR2007/002611, filed May 30, 2007, which is hereby incorporated by reference in its entirety.

### BACKGROUND

1. Technical Field

The present invention relates to a color interpolation device, more specifically to a color interpolation method and device that can improve image quality through color interpolation.

2. Description of the Related Art

Recent development of multimedia apparatuses has allowed complex images to be processed.

FIG. 1 is a block diagram illustrating a conventional color interpolation process.

As illustrated in FIG. 1, in accordance with a conventional color interpolation processing operation, RGB data, interpolated in a color interpolation unit 100, passes through a camera signal processing (hereinafter, referred to as “CSP”) intermediate processing unit 102. Then, the RGB data is converted into luminance (Y) data and chrominance (C) data in an RGB converting unit 104. Behind a video processing system, the converted Y data and C data pass through a noise removing unit 106 and undergo an edge enhancing process in an edge enhancing unit 108.

In the conventional color interpolation, an effective interpolation was usually used.

FIG. 2 illustrates a resolution chart video recovered by a conventional effective interpolation method.

Referring to FIG. 2, in accordance with the conventional, typical effective interpolation method, wrong color is generated in the vicinity of minute edge having 700 or more, and zipper-shaped artifacts are generated around the edge.

### SUMMARY

As described above, the present invention, which is contrived to solve the aforementioned problems, provides a color interpolation method and a device that perform color interpolation by using edge directional information.

The present invention provides a color interpolation method and a device that can prevent wrong color from being generated in the vicinity of minute edge.

The present invention provides a color interpolation method and a device that can prevent zipper-shaped artifacts from being generated around the edge when a color interpolation process is performed.

Other problems that the present invention solves will become more apparent through the following description.

To solve the above problems, an aspect of the present invention features a color interpolation method.

According to an embodiment of the present invention, a color interpolation method can include (a) extracting a pixel value only from a Bayer pattern image regardless of R, G and B values and computing edge directional information; (b) determining a condition of the edge directional information, computed in the step of (a), among a plurality of predetermined conditions, each of the plurality of predetermined conditions corresponding to a color interpolation parameter computing algorithm; and (c) computing a color interpolation parameter based on the color interpolation parameter computing algorithm corresponding to the condition of the edge directional information, determined in the step of (b).

The edge directional information can include edge vertical directional information and edge horizontal directional information.

Delta_V1 and delta_V2 are computed by the following formulas, respectively, and

$$delta\_V 1 = \frac{( \vert P 5 - P 1 \vert + \vert P 5 - P 9 \vert )}{2}$$

$$delta\_V 2 = \frac{( \vert P 2 - P 7 \vert + \vert P 3 - P 8 \vert )}{2}$$

the vertical directional information V_comp is computed by the following formula using the delta_V1 and delta_V2, the P1, P2, P3, P5, P8 and P9 being pixel values in a Bayer pattern image regardless of R, G and B components:

V_comp=delta_{—}V1+delta_{—}V2

Delta_H1 and delta_H2 are computed by the following formulas, respectively, and

$$delta\_H 1 = \frac{( \vert P 5 - P 4 \vert + \vert P 5 - P 6 \vert )}{2}$$

$$delta\_H 2 = \frac{( \vert P 2 - P 3 \vert + \vert P 7 - P 8 \vert )}{2}$$

the vertical directional information H_comp is computed by the following formula using the delta_H1 and delta_H2, the P1, P2, P3, P5, P8 and P9 being pixel values in a Bayer pattern image regardless of R, G and B components:

H_comp=delta_{—}H1+delta_{—}H2

The plurality of predetermined conditions can include a first condition, in which the vertical directional information is larger than a first threshold and the horizontal directional information is larger than a second threshold; a second condition, in which the vertical directional information is larger than the horizontal directional information; and a third condition, satisfying neither the first condition nor the second condition.

If the computed edge directional information satisfies the first condition and an R component is a center pixel in an RG line of the Bayer pattern image, parameters Gwn, Gws, Ges, Gen and Gout are computed by the following formulas in the step of (c):

$$Gwn = \frac{( G 1 + G 3 + G 6 + G 4 )}{4}$$

$$Gws = \frac{( G 6 + G 8 + G 11 + G 9 )}{4}$$

$$Ges = \frac{( G 7 + G 9 + G 12 + G 10 )}{4}$$

$$Gen = \frac{( G 2 + G 4 + G 7 + G 5 )}{4}$$

$$Gout = R 3 + \frac{( Kr 1 + Kr 2 + Kr 3 + Kr 4 )}{4}$$

If the computed edge directional information satisfies the first condition and a G component is a center pixel in an GB line of the Bayer pattern image, parameters Gn, Gw, Gs and Ge are computed by the following formulas in the step of (c):

$$Gn = \frac{( G 1 + G 2 + G 5 + G 3 )}{4}$$

$$Gw = \frac{( G 2 + G 4 + G 7 + G 5 )}{4}$$

$$Gs = \frac{( G 5 + G 7 + G 9 + G 8 )}{4}$$

$$Ge = \frac{( G 3 + G 5 + G 8 + G 6 )}{4}$$

if the computed edge directional information satisfies the second condition and an R component is a center pixel in an RG line of the Bayer pattern image, parameters Gwn, Gws, Ges, Gen and Gout are computed by the following formulas in the step of (c):

$$Gwn = \frac{( G 3 + G 4 )}{2}$$

$$Gws = \frac{( G 8 + G 9 )}{2}$$

$$Ges = \frac{( G 9 + G 10 )}{2}$$

$$Gen = \frac{( G 4 + G 5 )}{2}$$

$$Gout = R 3 + \frac{( Kr 2 + Kr 4 )}{2}$$

If the computed edge directional information satisfies the second condition and a G component is a center pixel in an GB line of the Bayer pattern image, parameters Gn, Gw, Gs and Ge are computed by the following formulas in the step of (c):

$$Gn = \frac{( G 2 + G 3 )}{2}$$

$$Gw = \frac{( G 4 + G 5 )}{2}$$

$$Gs = \frac{( G 7 + G 8 )}{2}$$

$$Ge = \frac{( G 5 + G 6 )}{2}$$

If the computed edge directional information satisfies the third condition and an R component is a center pixel in an RG line of the Bayer pattern image, parameters Gwn, Gws, Ges, Gen and Gout are computed by the following formulas in the step of (c):

$$Gwn = \frac{( G 1 + G 6 )}{2}$$

$$Gws = \frac{( G 6 + G 11 )}{2}$$

$$Ges = \frac{( G 7 + G 12 )}{2}$$

$$Gen = \frac{( G 2 + G 7 )}{2}$$

$$Gout = R 3 + \frac{( Kr 1 + Kr 3 )}{2}$$

If the computed edge directional information satisfies the third condition and an G component is a center pixel in an GB line of the Bayer pattern image, parameters Gn, Gw, Gs and Ge are computed by the following formulas in the step of (c):

$$Gn = \frac{( G 1 + G 5 )}{2}$$

$$Gw = \frac{( G 2 + G 7 )}{2}$$

$$G s = \frac{( G 5 + G 9 )}{2}$$

$$Ge = \frac{( G 3 + G 8 )}{2}$$

To solve the above problems, an aspect of the present invention features a color interpolation device.

According to an embodiment of the present invention, a color interpolation device can include an edge directional information computing unit, extracting a pixel value only from a Bayer pattern image regardless of R, G and B values and computing edge directional information; an edge directional information condition determining unit, determining a condition of the edge directional information, outputted from the edge directional information computing unit, among a plurality of predetermined conditions, each of the plurality of predetermined conditions corresponding to a color interpolation parameter computing algorithm; and a parameter computing unit, computing a color interpolation parameter based on the color interpolation parameter computing algorithm corresponding to the condition of the edge directional information, determined by the edge directional information condition determining unit.

The edge directional information computing unit can include the edge directional information computing unit comprises a horizontal directional information computing unit, computing edge horizontal directional information, and a vertical directional information computing unit, computing edge vertical directional information.

Delta_V1 and delta_V2 are computed by the following formulas, respectively, and

$$delta\_V 1 = \frac{( \vert P 5 - P 1 \vert + \vert P 5 - P 9 \vert )}{2}$$

$$delta\_V 2 = \frac{( \vert P 2 - P 7 \vert + \vert P 3 - P 8 \vert )}{2}$$

the vertical directional information V_comp is computed by the following formula using the delta_V1 and delta_V2, the P1, P2, P3, P5, P8 and P9 being pixel values in a Bayer pattern image regardless of R, G and B components:

V_comp=delta_{—}V1+delta_{—}V2

Delta_H1 and delta_H2 are computed by the following formulas, respectively, and

$$delta\_H 1 = \frac{( \vert P 5 - P 4 \vert + \vert P 5 - P 6 \vert )}{2}$$

$$delta\_H 2 = \frac{( \vert P 2 - P 3 \vert + \vert P 7 - P 8 \vert )}{2}$$

the vertical directional information H_comp is computed by the following formula using the delta_H1 and delta_H2, the P1, P2, P3, P5, P8 and P9 being pixel values in a Bayer pattern image regardless of R, G and B components:

H_comp=delta_{—}H1+delta_{—}H2

The plurality of predetermined conditions can include the plurality of predetermined conditions can includes a first condition, in which the vertical directional information is larger than a first threshold and the horizontal directional information is larger than a second threshold; a second condition, in which the vertical directional information is larger than the horizontal directional information; and a third condition, satisfying neither the first condition nor the second condition, and the parameter computing unit can includes a first condition parameter computing unit computing a parameter based on a color interpolation parameter computing algorithm relating to the first condition; a second condition parameter computing unit, computing a parameter based on a color interpolation parameter computing algorithm relating to the second condition; and a third condition parameter computing unit, computing a parameter based on a color interpolation parameter computing algorithm relating to the third condition.

If the computed edge directional information satisfies the first condition and an R component is a center pixel in an RG line of the Bayer pattern image, parameters Gwn, Gws, Ges, Gen and Gout are computed by the following formulas in the step of (c):

$$Gwn = \frac{( G 1 + G 3 + G 6 + G 4 )}{4}$$

$$Gws = \frac{( G 6 + G 8 + G 11 + G 9 )}{4}$$

$$Ges = \frac{( G 7 + G 9 + G 12 + G 10 )}{4}$$

$$Gen = \frac{( G 2 + G 4 + G 7 + G 5 )}{4}$$

$$Gout = R 3 + \frac{( Kr 1 + Kr 2 + Kr 3 + Kr 4 )}{4}$$

If the computed edge directional information satisfies the first condition and a G component is a center pixel in an GB line of the Bayer pattern image, parameters Gn, Gw, Gs and Ge are computed by the following formulas in the step of (c):

$$Gn = \frac{( G 1 + G 2 + G 5 + G 3 )}{4}$$

$$Gw = \frac{( G 2 + G 4 + G 7 + G 5 )}{4}$$

$$Gs = \frac{( G 5 + G 7 + G 9 + G 8 )}{4}$$

$$Ge = \frac{( G 3 + G 5 + G 8 + G 6 )}{4}$$

If the computed edge directional information satisfies the second condition and an R component is a center pixel in an RG line of the Bayer pattern image, parameters Gwn, Gws, Ges, Gen and Gout are computed by the following formulas in the step of (c):

$$Gwn = \frac{( G 3 + G 4 )}{2}$$

$$Gws = \frac{( G 8 + G 9 )}{2}$$

$$Ges = \frac{( G 9 + G 10 )}{2}$$

$$Gen = \frac{( G 4 + G 5 )}{2}$$

$$Gout = R 3 + \frac{( Kr 2 + Kr 4 )}{2}$$

If the computed edge directional information satisfies the second condition and a G component is a center pixel in an GB line of the Bayer pattern image, parameters Gn, Gw, Gs and Ge are computed by the following formulas in the step of (c):

$$Gn = \frac{( G 2 + G 3 )}{2}$$

$$Gw = \frac{( G 4 + G 5 )}{2}$$

$$Gs = \frac{( G 7 + G 8 )}{2}$$

$$Ge = \frac{( G 5 + G 6 )}{2}$$

if the computed edge directional information satisfies the third condition and an R component is a center pixel in an RG line of the Bayer pattern image, parameters Gwn, Gws, Ges, Gen and Gout are computed by the following formulas in the step of (c):

$$Gwn = \frac{( G 1 + G 6 )}{2}$$

$$Gws = \frac{( G 6 + G 11 )}{2}$$

$$Ges = \frac{( G 7 + G 12 )}{2}$$

$$Gen = \frac{( G 2 + G 7 )}{2}$$

$$Gout = R 3 + \frac{( Kr 1 + Kr 3 )}{2}$$

The computed edge directional information satisfies the third condition and an G component is a center pixel in an GB line of the Bayer pattern image, parameters Gn, Gw, Gs and Ge are computed by the following formulas in the step of (c):

$$Gn = \frac{( G 1 + G 5 )}{2}$$

$$Gw = \frac{( G 2 + G 7 )}{2}$$

$$Gs = \frac{( G 5 + G 9 )}{2}$$

$$Ge = \frac{( G 3 + G 8 )}{2}$$

### BRIEF DESCRIPTION OF THE DRAWINGS

FIG. 1 is a block diagram illustrating a conventional color interpolation process;

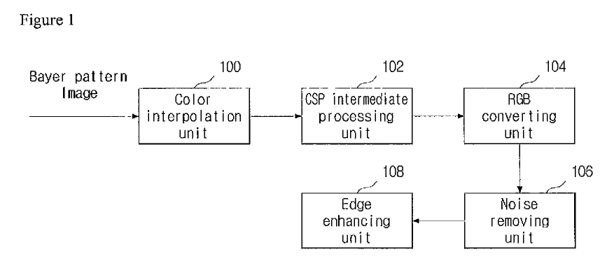

FIG. 2 illustrates a resolution chart video recovered by a conventional effective interpolation method;

FIG. 3 illustrates a case of an R component R3 in an RG line among Bayer pattern images, inputted in a color interpolation process, being a center pixel;

FIG. 4 illustrates a Bayer pattern image in case that G5 in a GB line is a center pixel;

FIG. 5 illustrates the structure of a color interpolation device in accordance with an embodiment of the present invention;

FIG. 6 is an example illustrating a 5×5 mask written with only pixel values regardless of a pixel component in a Bayer matrix;

FIG. 7 is a flow chart illustrating a general flow of a color interpolation method using edge directional information in accordance with an embodiment of the present invention; and

FIG. 8 illustrates a resolution chart image in the case of being applied with a color interpolation method in accordance with the present invention.

### DETAILED DESCRIPTION

The above objects, features and advantages will become more apparent through the below description with reference to the accompanying drawings.

Since there can be a variety of permutations and embodiments of the present invention, certain embodiments will be illustrated and described with reference to the accompanying drawings. This, however, is by no means to restrict the present invention to certain embodiments, and shall be construed as including all permutations, equivalents and substitutes covered by the spirit and scope of the present invention. Throughout the drawings, similar elements are given similar reference numerals. Throughout the description of the present invention, when describing a certain technology is determined to evade the point of the present invention, the pertinent detailed description will be omitted.

Terms such as “first” and “second” can be used in describing various elements, but the above elements shall not be restricted to the above terms. The above terms are used only to distinguish one element from the other. For instance, the first element can be named the second element, and vice versa, without departing the scope of claims of the present invention. The term “and/or” shall include the combination of a plurality of listed items or any of the plurality of listed items.

When one element is described as being “connected” or “accessed” to another element, it shall be construed as being connected or accessed to the other element directly but also as possibly having another element in between. On the other hand, if one element is described as being “directly connected” or “directly accessed” to another element, it shall be construed that there is no other element in between.

The terms used in the description are intended to describe certain embodiments only, and shall by no means restrict the present invention. Unless clearly used otherwise, expressions in the singular number include a plural meaning. In the present description, an expression such as “comprising” or “consisting of” is intended to designate a characteristic, a number, a step, an operation, an element, a part or combinations thereof, and shall not be construed to preclude any presence or possibility of one or more other characteristics, numbers, steps, operations, elements, parts or combinations thereof.

Unless otherwise defined, all terms, including technical terms and scientific terms, used herein have the same meaning as how they are generally understood by those of ordinary skill in the art to which the invention pertains. Any term that is defined in a general dictionary shall be construed to have the same meaning in the context of the relevant art, and, unless otherwise defined explicitly, shall not be interpreted to have an idealistic or excessively formalistic meaning.

Hereinafter, some embodiments of the present invention will be described in detail with reference to the accompany drawings.

Before describing the present invention, an effective interpolation method as a typical color interpolation method will be firstly described.

The color interpolation for an inputted 5×5 Bayer pattern image is performed.

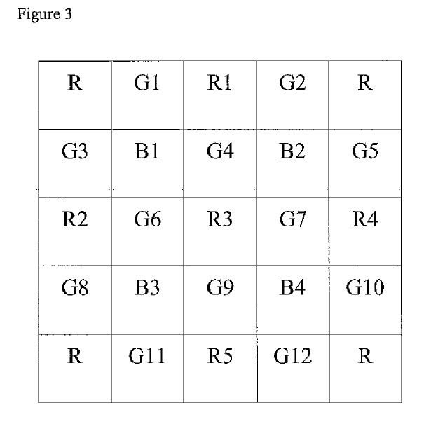

FIG. 3 illustrates a case of an R component R3 in an RG line among Bayer pattern images, inputted in a color interpolation process, being a center pixel.

Described first will be a typical interpolation method of a case in which R3 is a center pixel, as illustrated in FIG. 3.

Parameters Rn, Rw, Rs and Re and Kr1, Kr2, Kr3 and Kr4 are computed in case that an R component is a center pixel in a Bayer pattern.

The parameters Rn, Rw, Rs and Re are computed by the following Formula 1.

$$Rn = \frac{R 1 + R 3}{2} \\ Rw = \frac{R 2 + R 3}{2} \\ Rs = \frac{R 3 + R 5}{2} \\ Re = \frac{R 3 + R 4}{2} \qquad [ Formula 1 ]$$

Also, the parameters Kr1, Kr2, Kr3 and Kr4 are computed by the following Formula 2.

$$Kr 1 = G 4 - Rn \\ Kr 2 = G 6 - Rw \\ Kr 3 = G 9 - Rs \\ Kr 4 = G 7 - Re \qquad [ Formula 2 ]$$

If the parameters Rn, Rw, Rs and Re and Kr1, Kr2, Kr3 and Kr4 are computed by the Formula 1 and Formula 2, respectively, the final output value of a G component can be computed.

Gout, the final output value of the G component, is computed by the following Formula 3.

$$G out = R 3 + \frac{( Kr 1 + Kr 2 + Kr 3 + Kr 4 )}{4} \qquad [ Formula 3 ]$$

To evaluate the final output value of an interpolated B component, parameters Gwn, Gws, Ges and Gen and Kb1, Kb2, Kb3 and Kb4 must be computed.

The parameters Gwn, Gws, Ges and Gen are computed by the following Formula 4.

$$Gwn = \frac{G 1 + G 3 + G 6 + G 4}{4} \\ Gws = \frac{G 6 + G 8 + G 11 + G 9}{4} \\ Ges = \frac{G 7 + G 9 + G 12 + G 10}{4} \\ Gen = \frac{G 2 + G 4 + G 7 + G 5}{4} \qquad [ Formula 4 ]$$

The parameters Kb1, Kb2, Kb3 and Kb4 are also computed by the following Formula 5.

Kb1=Gwn−B1

Kb1=Gwn−B1

Kb2=Gen−B2

Kb3=Gws−B3

Kb4=Ges−B4 [Formula 5]

If the parameters computed by the Formula 4 and Formula 5 are used, an output value of the interpolated B component can be evaluated by the following Formula 6.

$$B out = G out - \frac{( Kb 1 + Kb 2 + Kb 3 + Kb 4 )}{4} \qquad [ Formula 6 ]$$

In the meantime, an output value of the interpolated R component is identical to the R3, a center pixel, as shown in the following Formula 7.

Rout=3 [Formula 7]

The case of the R component being the center pixel has been already described with reference to FIG. 3. Considering that the R component and the B component exchange their positions with each other in the Bayer pattern image, the same method can be applied to the case of the center pixel being the B component in a GB line.

Next, the typical interpolation method in case that G5 is the center pixel in the GB line will be described.

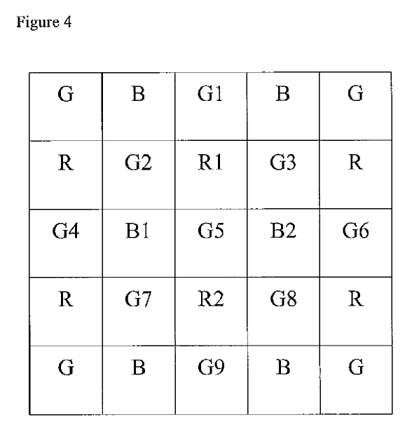

FIG. 4 illustrates a Bayer pattern image in case that G5 is a center pixel in a GB line.

In case that the G component is the center pixel in the GB line of the Bayer pattern, parameters Gn, Gw, Gs and Ge and Kr1, Kr2, Kb1 and Kb2 are computed.

The parameters Gn, Gw, Gs and Ge are computed by the following Formula 8.

$$Gn = \frac{( G 1 + G 2 + G 5 + G 3 )}{4} \\ Gw = \frac{( G 2 + G 4 + G 7 + G 5 )}{4} \\ Gs = \frac{( G 5 + G 7 + G 9 + G 8 )}{4} \\ Ge = \frac{( G 3 + G 5 + G 8 + G 6 )}{4} \qquad [ Formula 8 ]$$

The parameters Kr1, Kr2, Kb1 and Kb2 are also computed by the following Formula 9.

Kr1=Gn−R1

Kr2=Gs−R2

Kb1=Gw−B1

Kb2=Ge−B2 [Formula 9]

If the parameters Gn, Gw, Gs and Ge and Kr1, Kr2, Kb1 and Kb2 are computed by the Formula 8 and Formula 9, respectively, the interpolated final output value of R, G and B components can be computed.

Gout, the final output value of the G component, is identical to the G5 as shown in the following Formula 10.

Gout=G5 [Formula 10]

Rout, the final output value of the R Component, is computed by the following Formula 11.

$$R out = G 5 - \frac{( Kr 1 + Kr 2 )}{2} \qquad [ Formula 11 ]$$

Finally, Bout, the final output value of the B component, is computed by the following Formula 12.

$$B out = G 5 - \frac{( Kb 1 + Kb 2 )}{2} \qquad [ Formula 12 ]$$

The case of the G component being the center pixel in the GB line was described with reference to FIG. 4. Considering that the R component and the B component exchange their positions with each other in the Bayer pattern image, the same method can be applied to the case of the C component being the center pixel in a RG line.

The above description is related to the previously used typical effective interpolation. For the reference, since the above formulas were already well-known through the following publication, any person of ordinary skill in the art shall be able to easily understand the meaning and object of the pertinent formulas although additional description is omitted. (Soo-Chang Pei, Fellow, IEE E, Io-Kuong Tam, Effective Color Interpolation in CCD Color Filter Arrays Using Signal Correlation, IEEE transaction on circuits and systems for video technology, Vol. 13(6), June 2003.)

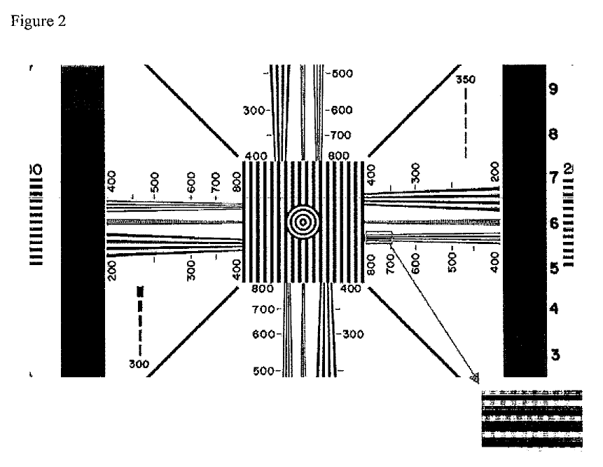

As described above, in accordance with the conventional interpolation method, as shown in a resolution chart video of FIG. 2, wrong color is generated in the vicinity of minute edge having 700 or more. Beside that, zipper-shaped artifacts are generated in the vicinity of edge.

To solve these problems, the present invention computes a new parameter of edge directional information and calculates color interpolation parameters by each different method according to the edge directional information.

To compute the edge directional information, a 5×5 mask having a pixel value of each component only is used regardless of the R, G and B components of a Bayer pattern.

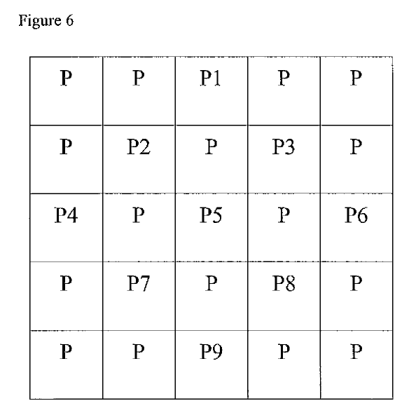

FIG. 6 is an example illustrating a 5×5 mask written with pixel values only in a Bayer matrix regardless of a pixel component.

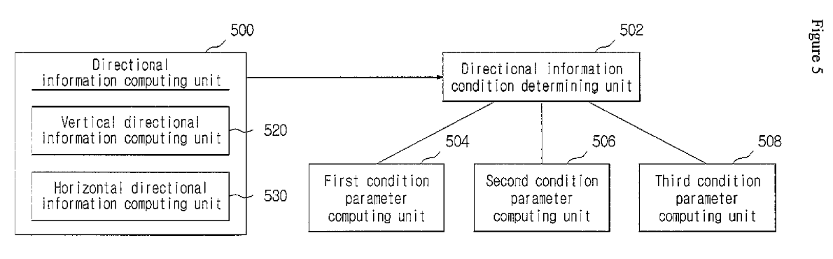

Also, FIG. 5 illustrates the structure of a color interpolation device in accordance with an embodiment of the present invention.

Referring to FIG. 5, the color interpolation device in accordance with an embodiment of the present invention can include a directional information computing unit 500, a directional information condition determining unit 502, a first condition parameter computing unit 504, a second condition parameter computing unit 506 and a third condition parameter computing unit 508. The directional information computing unit 500 can include a vertical directional information computing unit 520 and a horizontal directional information computing unit 530.

The directional information computing unit 500 computes edge directional information. The edge directional information is extracted by using a 5×5 mask value, illustrated in FIG. 5. The vertical directional information computing unit 520 computes edge vertical directional information, and the horizontal directional information computing unit 530 computes edge horizontal directional information. The horizontal and vertical directional information is a numerically expressed integer.

In accordance with an embodiment of the present invention, the edge vertical directional information is computed by using the difference in vertically disposed pixel values in a 5×5 mask, and the edge horizontal directional information is computed by using the difference in horizontally disposed pixel values in the 5×5 mask.

The more detailed method for computing the vertical directional information and the horizontal directional information will be described through additional drawings.

The directional information condition determining unit 502 determines which one of the predetermined conditions the directional information, computed in the directional information computing unit 500, belongs to.

Here, the first condition of the predetermined conditions satisfies the case of the vertical directional information being larger than a first threshold and the horizontal directional information being larger than a second threshold.

In case that the vertical directional information and the horizontal directional information, extracted in the directional information computing unit 500, are satisfied with the first condition, the directional information condition determining unit 502 controls the first condition parameter computing unit 504 to compute a color interpolation parameter.

The second condition of the predetermined conditions satisfies the case of the vertical directional information being larger than the horizontal directional information.

In case that the vertical directional information and the horizontal directional information, extracted in the directional information computing unit 500, are satisfied with the second condition, the directional information condition determining unit 502 controls the second condition parameter computing unit 506 to compute the color interpolation parameter.

However, in case that the output value of the directional information computing unit 500 satisfies both the first condition and the second condition, the directional information condition determining unit 502 controls the first condition parameter computing unit 504 to compute the color interpolation parameter

The third condition of the predetermined conditions is related to the case of the vertical directional information and the horizontal directional information satisfying neither the first condition nor the second condition. In this case, the directional information condition determining unit 502 controls the third condition parameter computing unit 508 to compute the color interpolation parameter.

The first condition parameter computing unit 504, the second condition parameter computing unit 506 and the third condition parameter computing unit 508 compute the color interpolation according to a predetermined computing method.

The first condition parameter computing unit 504, the second condition parameter computing unit 506 and the third condition parameter computing unit 508 compute the color interpolation parameter by distinguishing a case of R3 being the center pixel in the RG line (B is the center pixel in a GE line) and another case of G5 being the center pixel in the GB line (G is the center pixel in the RG line).

The first condition parameter computing unit 504, the second condition parameter computing unit 506 and the third condition parameter computing unit 508 compute the parameters Gout, Gwn, Gws, Ges and Gen by each different method in case that R3 is the center pixel in the RG line (B is the center pixel in a GE line) and compute the parameters Gn, Gw, Gs and Ge by each different method in case that G5 is the center pixel in the GB line (G is the center pixel in the RG line).

The formulas by which the aforementioned color interpolation parameters are computed according to each different condition will be described later in detail.

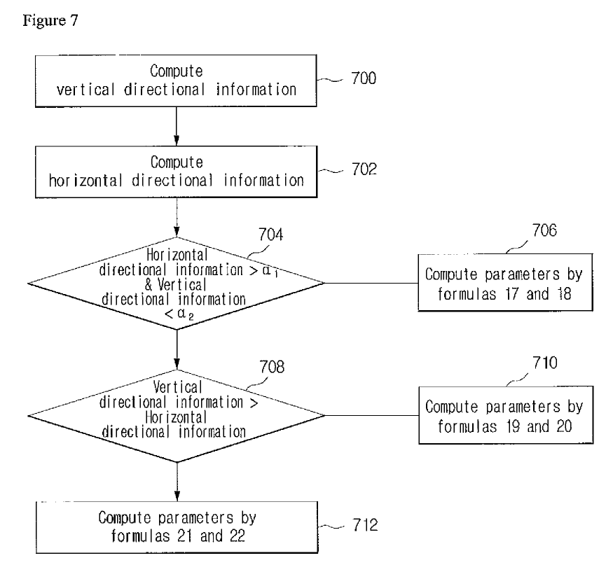

FIG. 7 is a flow chart illustrating a general flow of a color interpolation method using edge directional information in accordance with an embodiment of the present invention.

To perform color interpolation by using edge directional information, edge vertical directional information is firstly computed in a step represented by 700.

To compute the vertical directional information, two parameters delta_V1 and delta_V2 are computed. The two parameters delta_V1 and delta_V2 are computed by the following Formula 13.

$$delta\_V 1 = \frac{( \vert P 5 - P 1 \vert + \vert P 5 - P 9 \vert )}{2} \\ delta\_V 2 = \frac{( \vert P 2 - P 7 \vert + \vert P 3 - P 8 \vert )}{2} \qquad [ Formula 13 ]$$

As shown in the Formula 13, the parameter delta_V1 is computed by using the values of pixels disposed above and below the center pixel, and the parameter delta_V2 is computed by using the values of pixels provided in two rows adjacent to the center row.

By using the two parameters delta_V1 and delta_V2, computed by Formula 13, the vertical directional information, V_comp, is computed by the following Formula 14.

V_comp=delta_{—}V1+delta_{—}V2 [Formula 14]

When it comes to formulas for computing the vertical directional information, the delta_V1 and the delta_V2, the present invention is not limited to the aforementioned formulas. It shall be also evident to any person of ordinary skill in the art that they can be computed in various ways by using the parameters used in the aforementioned Formulas. For example, the delta_V1 and the delta_V2 can be divided by another integer instead of 2. Alternatively, a value that is not divided by 2 can be used.

If the vertical directional information is computed, the horizontal directional information is computed in a step represented by 702.

To compute the horizontal directional information, two parameters delta_H1 and delta_H2 are computed. The two parameters delta_H1 and delta_H2 are computed by the following Formula 15.

$$delta\_H 1 = \frac{( \vert P 5 - P 4 \vert + \vert P 5 - P 6 \vert )}{2} \\ delta\_H 2 = \frac{( \vert P 2 - P 3 \vert + \vert P 7 - P 8 \vert )}{2} \qquad [ Formula 15 ]$$

As shown in the Formula 15, the parameter delta_H1 is computed by using the values of pixels disposed in opposite sides of the center pixel, and the parameter delta_H2 is computed by using the values of pixels in columns provided above and below the center column.

By using the two parameters delta_H1 and delta_H2, computed by Formula 15, the horizontal directional information, H_comp, is computed by the following Formula 16.

H_comp=delta_{—}H1+delta_{—}H2 [Formula 16]

If the vertical directional information and the horizontal directional information are computed, in a step represented by 704, it is determined whether the first condition satisfies the case of the horizontal directional information being larger than a first threshold a1 and the horizontal directional information being larger than a second threshold a2.

In case that the vertical directional information and the horizontal directional information satisfy the first condition, and R3 is the center pixel in the RG line, the Gwn, Gws, Ges, Gen and Gout are computed by Formula 17. By referring to the aforementioned parameter, the Gwn, Gws, Ges, Gen and Gout are computed by the same method as the existing parameter formula.

$$Gwn = \frac{( G 1 + G 3 + G 6 + G 4 )}{4} \\ Gws = \frac{( G 6 + G 8 + G 11 + G 9 )}{4} \\ Ges = \frac{( G 7 + G 9 + G 12 + G 10 )}{4} \\ Gen = \frac{( G 2 + G 4 + G 7 + G 5 )}{4} \\ Gout = R 3 + \frac{( Kr 1 + Kr 2 + Kr 3 + Kr 4 )}{4} \qquad [ Formula 17 ]$$

The identical method can be applied to the case bo B being the center line in the GB line, considering that the R and B exchange their positions with each other.

In case that the vertical directional information and the horizontal directional information satisfy the first condition, and G5 is the center pixel in the GB line, the Gn, Gw, Gs and Ge are computed by Formula 18.

$$Gn = \frac{( G 1 + G 2 + G 5 + G 3 )}{4} \\ Gw = \frac{( G 2 + G 4 + G 7 + G 5 )}{4} \\ Gs = \frac{( G 5 + G 7 + G 9 + G 8 )}{4} \\ Ge = \frac{( G 3 + G 5 + G 8 + G 6 )}{4} \qquad [ Formula 18 ]$$

The same method as Formula 18 can be applied to the case of G being the center line in the RG line.

In case that the vertical directional information and the horizontal directional information do not satisfy the first condition, it is determined whether a second condition, in which the vertical directional information is larger than the horizontal directional information, is satisfied in a step represented by 708.

In case that the second condition is satisfied, and R3 is the center pixel in the RG line, the Gwn, Gws, Ges, Gen and Gout are computed by the following Formula 19.

$$Gwn = \frac{( G 3 + G 4 )}{2} \\ Gws = \frac{( G 8 + G 9 )}{2} \\ Ges = \frac{( G 9 + G 10 )}{2} \\ Gen = \frac{( G 4 + G 5 )}{2} \\ Gout = R 3 + \frac{( Kr 2 + Kr 4 )}{2} \qquad [ Formula 19 ]$$

The identical method can be applied to the case of B being the center line in the GB line, considering that R and B exchange their positions with each other.

In case that the vertical directional information and the horizontal directional information satisfy the second condition, and G5 is the center pixel in the GB line, the Gn, Gw, Gs and Ge are computed by Formula 20.

$$Gn = \frac{( G 2 + G 3 )}{2} \\ Gw = \frac{( G 4 + G 5 )}{2} \\ Gs = \frac{( G 7 + G 8 )}{2} \\ Ge = \frac{( G 5 + G 6 )}{2} \qquad [ Formula 20 ]$$

The same method as Formula 20 can be applied to the case of G being the center pixel in the RG line.

In case that the vertical directional information and the horizontal directional information do not satisfy the first condition and the second condition, and R3 is the center pixel in the RG line, the Gwn, Gws, Ges, Gen and Gout are computed by the following Formula 21.

$$Gwn = \frac{( G 1 + G 6 )}{2} \\ Gws = \frac{( G 6 + G 11 )}{2} \\ Ges = \frac{( G 7 + G 12 )}{2} \\ Gen = \frac{( G 2 + G 7 )}{2} \\ Gout = R 3 + \frac{( Kr 1 + Kr 3 )}{2} \qquad [ Formula 21 ]$$

The identical method can be applied to the case of B being the center line in the GB line, considering that the R and B exchange their positions with each other.

In case that the vertical directional information and the horizontal directional information satisfy the second condition, and Gs is the center pixel in the GB line, the Gn, Gw, Gs and Ge are computed by Formula 22.

$$Gn = \frac{( G 1 + G 5 )}{2} \\ Gw = \frac{( G 2 + G 7 )}{2} \\ Gs = \frac{( G 5 + G 9 )}{2} \\ Ge = \frac{( G 3 + G 8 )}{2} \qquad [ Formula 22 ]$$

The same method as Formula 22 can be applied to the case of G being the center pixel in the RG line.

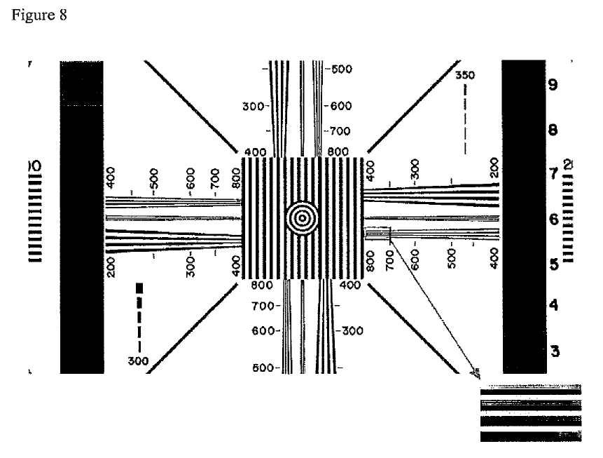

FIG. 8 illustrates a resolution chart image when a color interpolation method is applied in accordance with the present invention.

In the case of FIG. 2, in which the conventional color interpolation method is applied, wrong color was generated in the vicinity of minute edge having 700 or more. Besides, zipper-shaped artifacts were generated in the vicinity of edge. However, in the case of recovering with the color interpolation method of the present invention, most of the original colors are recovered without generating wrong color in the vicinity of minute edge, and the zipper-shaped artifacts are not generated. Similar to the existing color interpolation method, it can be recognized that the same quality color is recovered without deformation when color video such as a flower image is applied.

As described above, the present invention can prevent wrong color from being generated in the vicinity of minute edge and zipper-shaped artifacts from being generated in the vicinity of edge, by using edge directional information and computing parameters by each different algorithm according to conditions of the edge directional information.

The drawings and detailed description are only examples of the present invention, serve only for describing the present invention and by no means limit or restrict the spirit and scope of the present invention. Thus, any person of ordinary skill in the art shall understand that a large number of permutations and other equivalent embodiments are possible. The true scope of the present invention must be defined only by the spirit of the appended claims.

What is claimed is:

1. A color interpolation method, comprising:
(a) extracting a pixel value only from a Bayer pattern image regardless of R, G and B values and computing edge directional information;
(b) determining a condition of the edge directional information, computed in the step of (a), among a plurality of predetermined conditions, each of the plurality of predetermined conditions corresponding to a color interpolation parameter computing algorithm; and
(c) computing a color interpolation parameter based on the color interpolation parameter computing algorithm corresponding to the condition of the edge directional information, determined in the step of (b).

2. The color interpolation method of claim 1, wherein the edge directional information comprises edge vertical directional information and edge horizontal directional information.

3. The color interpolation method of claim 2, wherein delta_V1 and delta_V2 are computed by the following formulas, respectively, and
$$delta\_V 1 = \frac{( \vert P 5 - P 1 \vert + \vert P 5 - P 9 \vert )}{2} \\ delta\_V 2 = \frac{( \vert P 2 - P 7 \vert + \vert P 3 - P 8 \vert )}{2} \qquad$$
the vertical directional information V_comp is computed by the following formula using the delta_V1 and delta_V2, the P1, P2, P3, P5, P8 and P9 being pixel values in a Bayer pattern image regardless of R, G and B components.
V_comp=delta_{—}V1+delta_{—}V2

4. The color interpolation method of claim 3, wherein delta_H1 and delta_H2 are computed by the following formulas, respectively, and
$$\begin{matrix}delta\_ H 1 = \frac{( \vert P 5 - P 4 \vert + \vert P 5 - P 6 \vert )}{2} \\ delta\_ H 2 = \frac{( \vert P 2 - P 3 \vert + \vert P 7 - P 8 \vert )}{2}\end{matrix}$$
the vertical directional information H_comp is computed by the following formula using the delta_H1 and delta_H2, the P1, P2, P3, P5, P8 and P9 being pixel values in a Bayer pattern image regardless of R, G and B components.
H_comp=delta_{—}H1+delta_{—}H2

5. The color interpolation method of claim 2, wherein the plurality of predetermined conditions comprises:
a first condition, in which the vertical directional information is larger than a first threshold and the horizontal directional information is larger than a second threshold;
a second condition, in which the vertical directional information is larger than the horizontal directional information; and
a third condition, satisfying neither the first condition nor the second condition.

6. The color interpolation method of claim 5, wherein if the computed edge directional information satisfies the first condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 1 + G 3 + G 6 + G 4 )}{4} \\ Gws = \frac{( G 6 + G 8 + G 11 + G 9 )}{4} \\ Ges = \frac{( G 7 + G 9 + G 12 + G 10 )}{4} \\ Gen = \frac{( G 2 + G 4 + G 7 + G 5 )}{4} \\ Gout = R 3 + \frac{( Kr 1 + Kr 2 + Kr 3 + Kr 4 )}{4}\end{matrix}$$

7. The color interpolation method of claim 5, wherein if the computed edge directional information satisfies the first condition and a G component is a center pixel in an GB line of the Bayer pattern image, parameters Gn, Gw, Gs and Ge are computed by the following formulas in the step of (c):
$$\begin{matrix}Gn = \frac{( G 1 + G 2 + G 5 + G 3 )}{4} \\ Gw = \frac{( G 2 + G 4 + G 7 + G 5 )}{4} \\ Gs = \frac{( G 5 + G 7 + G 9 + G 8 )}{4} \\ Ge = \frac{( G 3 + G 5 + G 8 + G 6 )}{4}\end{matrix}$$

8. The color interpolation method of claim 5, wherein if the computed edge directional information satisfies the second condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 3 + G 4 )}{2} \\ Gws = \frac{( G 8 + G 9 )}{2} \\ Ges = \frac{( G 9 + G 10 )}{2} \\ Gen = \frac{( G 4 + G 5 )}{2} \\ Gout = R 3 + \frac{( Kr 2 + Kr 4 )}{2}\end{matrix}$$

9. The color interpolation method of claim 5, wherein if the computed edge directional information satisfies the second condition and a G component is a center pixel in an GB line of the Bayer pattern image, parameters Gn, Gw, Gs and Ge are computed by the following formulas in the step of (c):
$$\begin{matrix}Gn = \frac{( G 2 + G 3 )}{2} \\ Gw = \frac{( G 4 + G 5 )}{2} \\ Gs = \frac{( G 7 + G 8 )}{2} \\ Ge = \frac{( G 5 + G 6 )}{2}\end{matrix}$$

10. The color interpolation method of claim 5, wherein if the computed edge directional information satisfies the third condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 1 + G 6 )}{2} \\ Gws = \frac{( G 6 + G 11 )}{2} \\ Ges = \frac{( G 7 + G 12 )}{2} \\ Gen = \frac{( G 2 + G 7 )}{2} \\ Gout = R 3 + \frac{( Kr 1 + Kr 3 )}{2}\end{matrix}$$

11. The color interpolation method of claim 5, wherein if the computed edge directional information satisfies the third condition and an G component is a center pixel in an GB line of the Bayer pattern image, parameters Gn, Gw, Gs and Ge are computed by the following formulas in the step of (c):
$$\begin{matrix}Gn = \frac{( G 1 + G 5 )}{2} \\ Gw = \frac{( G 2 + G 7 )}{2} \\ Gs = \frac{( G 5 + G 9 )}{2} \\ Ge = \frac{( G 3 + G 8 )}{2}\end{matrix}$$

12. A color interpolation device, comprising:
an edge directional information computing unit, extracting a pixel value only from a Bayer pattern image regardless of R, G and B values and computing edge directional information;
an edge directional information condition determining unit, determining a condition of the edge directional information, outputted from the edge directional information computing unit, among a plurality of predetermined conditions, each of the plurality of predetermined conditions corresponding to a color interpolation parameter computing algorithm; and
a parameter computing unit, computing a color interpolation parameter based on the color interpolation parameter computing algorithm corresponding to the condition of the edge directional information, determined by the edge directional information condition determining unit.

13. The color interpolation device of claim 12, wherein the edge directional information computing unit comprises a horizontal directional information computing unit, computing edge horizontal directional information, and a vertical directional information computing unit, computing edge vertical directional information.

14. The color interpolation device of claim 13, wherein delta_V1 and delta_V2 are computed by the following formulas, respectively, and
$$\begin{matrix}delta\_ V 1 = \frac{( \vert P 5 - P 1 \vert + \vert P 5 - P 9 \vert )}{2} \\ delta\_ V 2 = \frac{( \vert P 2 - P 7 \vert + \vert P 3 - P 8 \vert )}{2}\end{matrix}$$
the vertical directional information V_comp is computed by the following formula using the delta_V1 and delta_V2, the P1, P2, P3, P5, P8 and P9 being pixel values in a Bayer pattern image regardless of R, G and B components.
V_comp=delta_{—}V1+delta_{—}V2

15. The color interpolation device of claim 13, wherein delta_H1 and delta_H2 are computed by the following formulas, respectively, and
$$\begin{matrix}delta\_ H 1 = \frac{( \vert P 5 - P 4 \vert + \vert P 5 - P 6 \vert )}{2} \\ delta\_ H 2 = \frac{( \vert P 2 - P 3 \vert + \vert P 7 - P 8 \vert )}{2}\end{matrix}$$
the vertical directional information H_comp is computed by the following formula using the delta_H1 and delta_H2, the P1, P2, P3, P5, P8 and P9 being pixel values in a Bayer pattern image regardless of R, G and B components.
H_comp=delta_{—}H1+delta_{—}H2

16. The color interpolation device of claim 13, wherein the plurality of predetermined conditions comprises:
a first condition, in which the vertical directional information is larger than a first threshold and the horizontal directional information is larger than a second threshold;
a second condition, in which the vertical directional information is larger than the horizontal directional information; and
a third condition, satisfying neither the first condition nor the second condition, and
the parameter computing unit comprises:
a first condition parameter computing unit, computing a parameter based on a color interpolation parameter computing algorithm relating to the first condition;
a second condition parameter computing unit, computing a parameter based on a color interpolation parameter computing algorithm relating to the second condition; and
a third condition parameter computing unit, computing a parameter based on a color interpolation parameter computing algorithm relating to the third condition.

17. The color interpolation device of claim 16 wherein if the computed edge directional information satisfies the first condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 1 + G 3 + G 6 + G 4 )}{4} \\ Gws = \frac{( G 6 + G 8 + G 11 + G 9 )}{4} \\ Ges = \frac{( G 7 + G 9 + G 12 + G 10 )}{4} \\ Gen = \frac{( G 2 + G 4 + G 7 + G 5 )}{4} \\ Gout = R 3 + \frac{( Kr 1 + Kr 2 + Kr 3 + Kr 4 )}{4}\end{matrix}$$

18. The color interpolation device of claim 16 wherein if the computed edge directional information satisfies the first condition and a G component is a center pixel in an GB line of the Bayer pattern image, parameters Gn, Gw, Gs and Ge are computed by the following formulas in the step of (c):
$$\begin{matrix}Gn = \frac{( G 1 + G 2 + G 5 + G 3 )}{4} \\ Gw = \frac{( G 2 + G 4 + G 7 + G 5 )}{4} \\ Gs = \frac{( G 5 + G 7 + G 9 + G 8 )}{4} \\ Ge = \frac{( G 3 + G 5 + G 8 + G 6 )}{4}\end{matrix}$$

19. The color interpolation device of claim 16 wherein if the computed edge directional information satisfies the second condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 3 + G 4 )}{2} \\ Gws = \frac{( G 8 + G 9 )}{2} \\ Ges = \frac{( G 9 + G 10 )}{2} \\ Gen = \frac{( G 4 + G 5 )}{2} \\ Gout = R 3 + \frac{( Kr 2 + Kr 4 )}{2}\end{matrix}$$

20. The color interpolation device of claim 16 wherein if the computed edge directional information satisfies the second condition and a G component is a center pixel in an GB line of the Bayer pattern image, parameters Gn, Gw, Gs and Ge are computed by the following formulas in the step of (c):
$$\begin{matrix}Gn = \frac{( G 2 + G 3 )}{2} \\ Gw = \frac{( G 4 + G 5 )}{2} \\ Gs = \frac{( G 7 + G 8 )}{2} \\ Ge = \frac{( G 5 + G 6 )}{2}\end{matrix}$$

21. The color interpolation device of claim 16 wherein if the computed edge directional information satisfies the third condition and an R component is a center pixel in an RG line of the Bayer pattern image, parameters Gwn, Gws, Ges, Gen and Gout are computed by the following formulas in the step of (c):
$$\begin{matrix}Gwn = \frac{( G 1 + G 6 )}{2} \\ Gws = \frac{( G 6 + G 11 )}{2} \\ Ges = \frac{( G 7 + G 12 )}{2} \\ Gen = \frac{( G 2 + G 7 )}{2} \\ Gout = R 3 + \frac{( Kr 1 + Kr 3 )}{2}\end{matrix}$$

22. The color interpolation device of claim 16 wherein the computed edge directional information satisfies the third condition and an G component is a center pixel in an GB line of the Bayer pattern image, parameters Gn, Gw, Gs and Ge are computed by the following formulas in the step of (c):
$$\begin{matrix}Gn = \frac{( G 1 + G 5 )}{2} \\ Gw = \frac{( G 2 + G 7 )}{2} \\ Gs = \frac{( G 5 + G 9 )}{2} \\ Ge = \frac{( G 3 + G 8 )}{2}\end{matrix}$$
